(19) United States
(12) Patent Application Publication
(10) Pub. No.: US 2009/0020595 A1
(43) Pub. Date: Jan. 22, 2009

(54) CONTAINER INCLUDING A DECORATIVE FILM AND BLANK FOR MAKING THE SAME

(76) Inventors: Duane F. Krogh, Bothell, WA (US); Patrice J.M. Calmels, Wheaton, IL (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 12/027,046

(22) Filed: Feb. 6, 2008

Related U.S. Application Data
(63) Continuation of application No. 60/951,078, filed on Jul. 20, 2007.

(51) Int. Cl. B65D 25/34; B31B 15/00

(52) U.S. Cl. 229/116.5; 493/111

(57) ABSTRACT

A container constructed from a blank of foldable sheet material. The container includes a decorative film attached to an exterior surface of the container. The container also includes a top wall and an opposing bottom wall, a back wall and an opposing front wall, and a pair of opposing side walls, wherein a first one of the walls and an adjacent second one of the walls includes the decorative film. The decorative film includes a holographic lens pattern thereon. The holographic lens pattern displays an image of an object suspended within the container when both of the first and second walls are viewed together.

### CROSS REFERENCE TO RELATED APPLICATIONS

This application claims priority to U.S. Provisional Patent Application No. 60/951,078, filed Jul. 20, 2007, which is assigned to the same assignee of the present invention, and which is hereby incorporated by reference in its entirety.

### BACKGROUND OF THE INVENTION

This invention relates generally to a container that includes a decorative film attached to an exterior surface of the container, and more particularly to a container that includes a decorative film including a holographic lens pattern for displaying a holographic image on the exterior surface of the container and methods of constructing the container from a blank.

It is well known in the retail industry to apply a decorative film to containers. Containers that include a decorative film that is attached to an exterior surface of the container are intended to attract the attention of consumers. The retailer hopes that by attracting the consumer's attention to the attractive container, the retailer will be able to sell more products included within the container.

At least some known decorative films may be reflective or include a lens pattern to attract consumers to the container and/or the product therein. Such lens patterns generally only apply an effect to each wall of the container, without forming one overall effect to the container, wherein multiple walls of the container cooperate together to apply the overall effect to the container. For example, each wall of the container may include the same repeated, tiled pattern of prismatic film to attract a consumer's attention. These known decorative films create a holographic and/or prismatic image on each wall of the container that the decorative film is applied to, but are not configured such that multiple walls of the container having the decorative film applied thereto cooperate with one another such that multiple walls of the container work together to create the holographic image.

### BRIEF DESCRIPTION OF THE INVENTION

In one aspect, a container constructed from a blank of foldable sheet material. The container includes a decorative film attached to an exterior surface of the container. The container also includes a top wall and an opposing bottom wall, a back wall and an opposing front wall, and a pair of opposing side walls, wherein a first one of the walls and an adjacent second one of the walls includes the decorative film. The decorative film includes a holographic lens pattern thereon. The holographic lens pattern displays an image of an object suspended within the container when both of the first and second walls are viewed together.

In another aspect, a method of constructing a container from a blank of foldable sheet material, wherein the container includes a decorative film including a holographic lens pattern. The method includes providing a blank comprising a plurality of panels connected along a plurality of fold lines, providing the decorative film on a first panel of the plurality of panels and a second panel of the plurality of panels such that the second panel is adjacent to the first panel, and configuring the holographic lens pattern to visually create an image of a three-dimensional object suspended within the container when the first and second panels are viewed together.

In still another aspect, a container constructed from a blank of foldable sheet material is provided. The container includes a decorative film attached to an exterior surface of the container. The container also includes at least two side walls adjacent to one another, wherein the side walls include the decorative film. The decorative film includes a holographic lens pattern thereon, and the holographic lens pattern displays an image of an object suspended within the container when both of the side walls are viewed together.

### BRIEF DESCRIPTION OF THE DRAWINGS

FIG. 1 is a top plan view of a blank of sheet material for constructing a container, according to one embodiment of the present invention.

FIG. 2 is a top plan view of a blank of sheet material for constructing a container, according to an alternative embodiment of the present invention.

FIG. 3 is a perspective view of an exemplary embodiment of a container formed from the blank shown in FIG. 1.

FIG. 4 is a perspective view of an alternative exemplary embodiment of a container formed from the blank shown in FIG. 1.

### DETAILED DESCRIPTION OF THE INVENTION

A stackable, collapsible container that includes a decorative holographic film, and a method for constructing the container is described in detail below. The container is constructed from a blank of sheet material using a machine. In one embodiment, the container is fabricated from a paperboard material. The container, however, may be fabricated using any suitable material, and therefore is not limited to a specific type of material. In alternative embodiments, the container is fabricated using cardboard, plastic, fiberboard, paperboard, foamboard, corrugated paper, a flexible material, a semi-flexible material, a rigid material, and/or any suitable material known to those skilled in the art and guided by the teachings herein provided.

In an exemplary embodiment, the container includes a decorative film including a holographic lens pattern for displaying a holographic image. The holographic image can relate to the product housed within the container or can be completely unrelated to the product housed in the container. The holographic lens pattern is intended to be configured such that a three-dimensional object appears to be floating within the container. As such, the container facilitates drawing a potential consumer's attention to the container and/or the product housed therein.

In one exemplary embodiment, the container includes at least one marking thereon including, without limitation, indicia that communicates the product, a manufacturer of the product and/or a seller of the product. For example, the marking may include printed text that indicates a product's name and briefly describes the product, logos and/or trademarks that indicate a manufacturer and/or seller of the product, and/or designs and/or ornamentation that attract attention. In another exemplary embodiment, the container is void of markings, such as, without limitation, indicia that communicates the product, a manufacturer of the product and/or a seller of the product. Furthermore, the container may have any suitable size, shape and/or configuration, i.e., any suitable number of sides having any suitable size, shape and/or configuration as described and/or illustrated herein. In one embodiment, the container includes a shape that provides functionality, such as a shape that facilitates packaging an item, a shape that facilitates transporting the container, and/or a shape that facilitates stacking and/or arrangement of a plurality of containers.

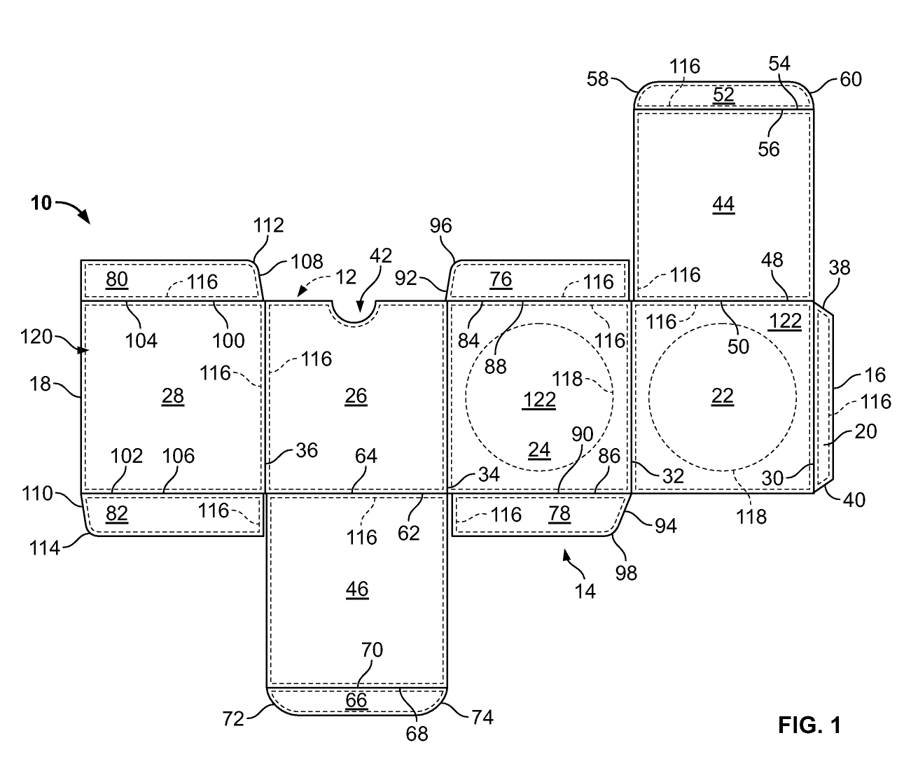

Referring now to the drawings, and more specifically to FIG. 1. Although, as described above, a container may have any suitable size, shape and/or configuration, FIG. 1 illustrates the construction or formation of one exemplary embodiment of a container. Specifically, FIG. 1 is a top plan view of a blank 10 of sheet material, such as, paperboard.

Blank 10 has a first or interior surface 12 and an opposing second or exterior surface 14. Further, blank 10 defines a leading edge 16 and an opposing trailing edge 18. Blank 10 includes, from leading edge 16 to trailing edge 18, a closure flap 20, a back panel 22, a first side panel 24, a front panel 26, and a second side panel 28 coupled together along preformed, generally parallel, fold lines 30, 32, 34, and 36, respectively. More specifically, closure flap 20 extends from back panel 22 along fold line 30, back panel 22 extends from first side panel 24 along fold line 32, first side panel 24 extends from front panel 26 along fold line 34, and front panel 26 extends from second side panel 28 along fold line 36. Fold lines 30, 32, 34, and 36, as well as other fold lines described herein, may include any suitable line of weakening and/or line of separation known to those skilled in the art and guided by the teachings herein provided.

In the exemplary embodiment, closure flap 20 includes angled edges 38 and 40. In an alternative embodiment, closure flap 20 may include more or less than two angled edges 38 and 40. In one embodiment, edges 38 and/or 40 are other than angled edges. Further, in the exemplary embodiment, front panel 26 includes a semi-circular cut-out portion 42. Cut-out portion 42 may be any shape, such as, but not limited to, square, rectangular, oblong, irregular, and/or any other shape that enables blank 10 and/or container 300 and/or 400 to function as described herein. In one embodiment, front panel 26 does not include cut-out portion 42.

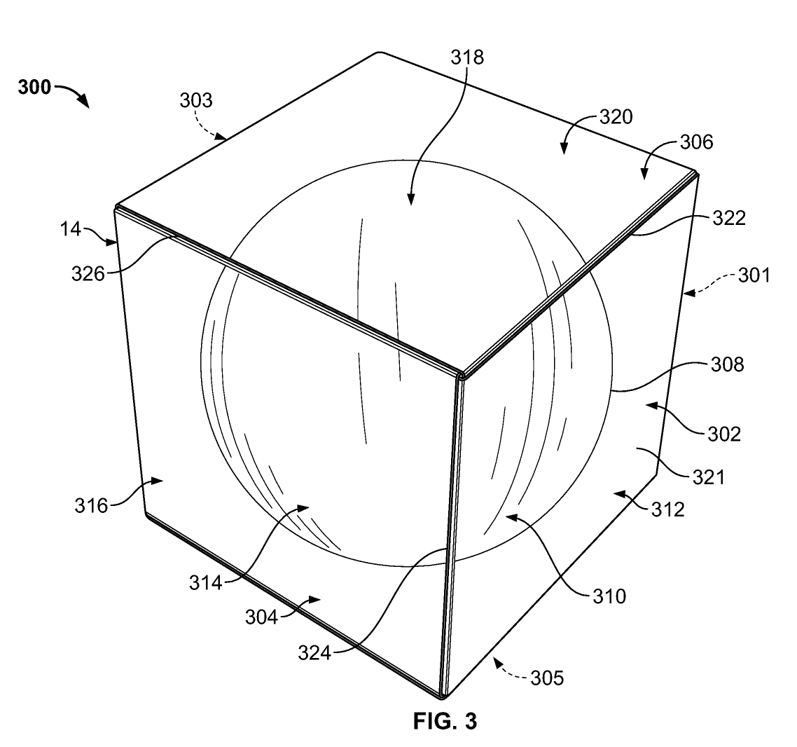

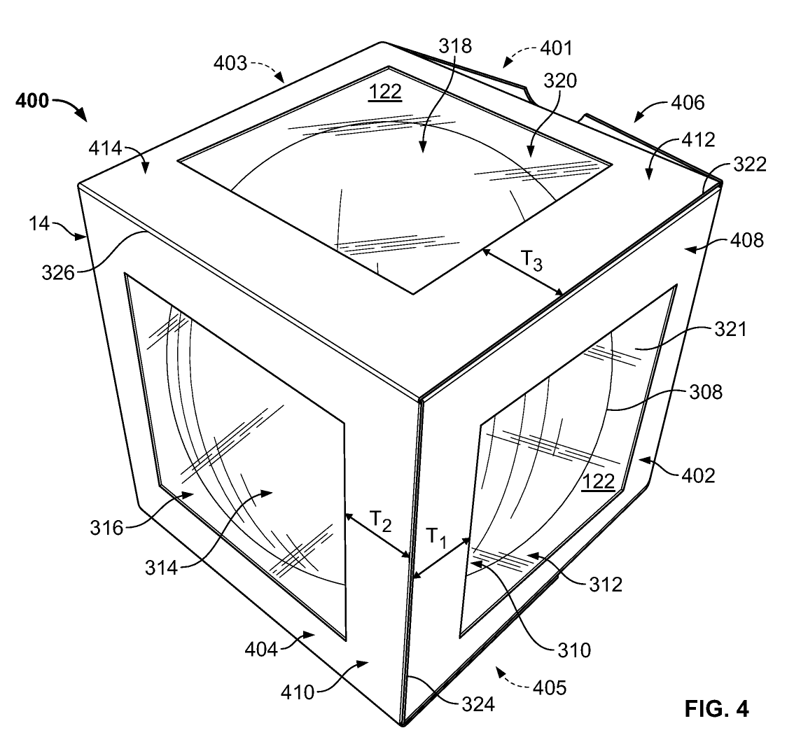

Blank 10 also includes a top panel 44 and a bottom panel 46. Each panel 22, 24, 26, 28, 44 and/or 46 is substantially square and substantially the same size as each other panel 22, 24, 26, 28, 44 and/or 46 such that the container, for example, container 300 and/or 400 (shown in FIGS. 3 and 4), is substantially cube-shaped. Alternatively, one or more panels 22, 24, 26, 28, 44 and/or 46 may be sized differently than any other panel 22, 24, 26, 28, 44 and/or 46. In one embodiment, panels 22, 24, 26, 28, 44 and/or 46 are other than quadrangularly-shaped.

Top panel 44 extends from a top edge 48 of back panel 22 along a fold line 50. Further, top panel 44 includes a top tuck flap 52 that extends from a front edge 54 of top panel 44 along a fold line 56. Top tuck flap 52 includes arcuate corners 58 and 60. In another embodiment, top tuck flap 52 may include non-arcuate corners (not shown). Bottom panel 46 extends from a bottom edge 62 of front panel 26 along a fold line 64. Further, bottom panel 46 includes a bottom tuck flap 66 that extends from a back edge 68 of bottom panel 46 along a fold line 70. Bottom tuck flap 66 includes arcuate corners 72 and 74. In an alternative embodiment, bottom tuck flap 66 may include non-arcuate corners (not shown).

Further, blank 10 includes a first top side flap 76, a first bottom side flap 78, a second top side flap 80, and a second bottom side flap 82. First top side flap 76 and first bottom side flap 78 extend from respective opposing edges 84 and 86 of first side panel 24 along fold lines 88 and 90, respectively. More specifically, first top side flap 76 extends from first side panel 24 along fold line 88, and first bottom side flap 78 extends from first side panel 24 along fold line 90. First top side flap 76 and first bottom side flap 78 include respective angled edges 92 and 94, and further include respective arcuate corners 96 and 98. In one embodiment, one or none of first side flaps 76 and 78 may include angled edges 92 and 94. Further, in another embodiment, one or none of side flaps 76 and 78 may include arcuate corners 96 and 98, and/or each side flap 76 and/or 78 may include one or more corners that are other than arcuate.

Similarly, second top side flap 80 and second bottom side flap 82 extend from opposing edges 100 and 102 of second side panel 28 along fold lines 104 and 106, respectively. More specifically, second top side flap 80 extends from second side panel 28 along fold line 104, and second bottom side flap 82 extends from second side panel 28 along fold line 106. Second top side flap 80 and second bottom side flap 82 include respective angled edges 108 and 110, and further include respective arcuate corners 112 and 114. In an alternative embodiment, one or none of side flaps 80 and 82 may include angled edges 108 and 110. Further, in another embodiment, some or none of side flaps 80 and 82 may include arcuate corners 112 and 114, and/or each side flap 80 and/or 82 may include one or more corners that are other than arcuate.

In the exemplary embodiment, blank 10 includes a decorative film 116 that displays a holographic image 118. Decorative film 116 is affixed to exterior surface 14 by an adhesive. However, in alternative embodiments, decorative film 116 is affixed or coupled to exterior surface 14 using any other chemical or mechanical fastening means. Film 116 may be applied to laminated board or paper used to form blank 10 using, for example, a water based adhesive. Furthermore, each of flap 20 and/or panels 22, 24, 26, 28, 44, 46, 52, 66 76, 78, 80 and/or 82 may have decorative film 116 applied thereon. Although each of flap 20 and/or panels 22, 24, 26, 28, 44, 46, 52, 66 76, 78, 80 and/or 82 is shown as including decorative film 116, less than all of flap 20 and/or panels 22, 24, 26, 28, 44, 46, 52, 66 76, 78, 80 and/or 82 may include film 116. In one embodiment, two adjacent panels 22, 24, 26, 28, 44, and/or 46 include film 116. In another embodiment, five panels 22, 24, 26, 28, and 44 include film 116. Further, although each of flap 20 and/or panels 22, 24, 26, 28, 44, 46, 52, 66 76, 78, 80 and/or 82 is shown as including a separate sheet 120 of film 116, one sheet 120 of film 116 may cover approximately all of exterior surface 14 of blank 10. Alternatively, surfaces 12 and/or 14 may include film 116 applied thereon.

Furthermore, decorative film 116 includes a lens pattern 122. Each panel 22, 24, 26, 28, 44, 46, 52, 66 76, 78, 80 and/or 82 to which film 116 is applied may include a lens pattern 122 that is different from the lens pattern on any other panel, and/or two or more panels 22, 24, 26, 28, 44, 46, 52, 66 76, 78, 80 and/or 82 may include the same lens pattern 122. Each lens pattern 122 is configured to individually provide a portion of a hologram having a three-dimensional effect. More specifically, lens patterns 122 are configured to combine to visually create a three-dimensional object suspended within the container formed from blank 10. In the exemplary embodiment, lens patterns 122 cooperate to create holographic image 118, which appears to be a three-dimensional floating sphere inside the container, such as container 300 and/or 400, formed from blank 10, as described in more detail below. Alternatively, lens patterns 122 combine to visually create image 118 of a three-dimensional floating object inside the container other than a sphere.

In one embodiment, film 116 is a known lens pattern containing film, such as, for example, the film manufactured by Wavefront Technology, Inc., Paramount, Calif. Lens patterns 122 may be defined within film 116 using known methods, such as, defining lens patterns 122 using a relief pattern (not shown), a fringe pattern (not shown), a phase diffraction grating (not shown), and/or an amplitude diffraction grating (not shown). Lens patterns 122 may also be configured such that film 116 may be considered to be a lenticular film. Lens patterns 122 may be pressed and/or embossed within film 116. In the exemplary embodiment, each lens pattern 122 includes concentric circles (not shown) defined within film 116. Furthermore, lens patterns 122 may include one or more layers (not shown) to define pattern 122. In one embodiment, film 116 includes a metallized layer (not shown), such as an aluminum layer, to facilitate increasing the amount of light reflected by film 116. The metallized layer may coat lens patterns 122 and/or be positioned between exterior surface 14 and lens patterns 122. In the exemplary embodiment, lens pattern 122 is a monochromatic pattern. In an alternative embodiment, lens pattern 122 is a color pattern.

More specifically, film 116 includes a film substrate (not shown) fabricated from any suitable material, for example, a resin-type material or a plastic material, such as, but not limited to, polyester, vinyl, or polycarbonate. Lens pattern 122 may be embossed into the substrate by heating the substrate, aligning an embossing template with the substrate, and applying pressure to the template. In another embodiment, the film substrate is formed with the embossed lens pattern 122 using an extrusion process. In still another embodiment, the substrate is coated with a coating (not shown), and the lens pattern 122 is embossed into the coating using heat and pressure and/or extrusion, as described above. In one embodiment, the coating is an ultraviolet (UV) curable polymer coating. Once lens pattern 122 is embossed into the substrate and/or coating, a metallized layer is applied over pattern 122 to reflect light entering pattern 122. The light reflected from lens pattern 122 creates a visually-perceivable pattern, shown, for example, in FIGS. 3 and 4.

To construct container 300 (shown in FIG. 3) and/or container 400 (shown in FIG. 4) from blank 10 shown in FIG. 1, flap 20 and panels 22, 24, 26, and 28 are each rotated about respective fold lines 30, 32, 34, and 36 toward interior surface 12 to form a generally right angle with an adjacent panel 22, 24, 26, and/or 28 and/or flap 20. An adhesive, such as, for example, glue and/or tape, is used to adhere exterior surface 14 of closure flap 20 to interior surface 12 of second side panel 28. As such, first side panel 24 defines a first side wall, such as first side wall 301 (shown in FIG. 3) and/or 401 (shown in FIG. 4); back panel 22 defines a back wall, such as back wall 302 (shown in FIG. 3) and/or 402 (shown in FIG. 4); front panel 26 defines a front wall, such as front wall 303 (shown in FIG. 3) and/or 403 (shown in FIG. 4); and second side panel 28 and closure flap 20 define a second side wall, such as, second side wall 304 (shown in FIG. 3) and/or 404 (shown in FIG. 4).

Bottom side flaps 78 and 82 are each rotated about respective fold lines 90 and 106 toward interior surface 12 of each respective side panel 24 and 28 to form generally right angles with each side panel 24 and 28. Bottom panel 46 is rotated about fold line 64 toward interior surface 12 of front panel 26 to form a generally right angle with front panel 26. An exterior surface 14 of each bottom side flap 78 and 82 is adjacent to interior surface 12 of bottom panel 46. Bottom tuck flap 66 is rotated about fold line 70 such that exterior surface 14 of flap 66 is adjacent to interior surface 12 of back panel 22 to secure bottom panel 46 in place. As such, bottom panel 46 and bottom side flaps 78 and 82 define a bottom wall, such as bottom wall 305 (shown in FIG. 3) and/or 405 (shown in FIG. 4).

Top side flaps 76 and 80 are each rotated about respective fold lines 88 and 104 toward interior surface 12 of each respective side panel 24 and 28 to form generally right angles with each side panel 24 and 28. Top panel 44 is rotated about fold line 50 toward interior surface 12 of back panel 22 to form a generally right angle with back panel 22. An exterior surface 14 of each top side flap 76 and 80 is adjacent to interior surface 12 of top panel 44. Top tuck flap 52 is rotated about fold line 56 such that exterior surface 14 of flap 52 is adjacent to interior surface 12 of front panel 26 to secure top panel 44 in place. As such, top panel 44 and top side flaps 76 and 80 define a top wall, such as top wall 306 (shown in FIG. 3) and/or 406 (shown in FIG. 4). Once container 300 and/or 400 is constructed, container 300 and/or 400 may hold any suitable item or items.

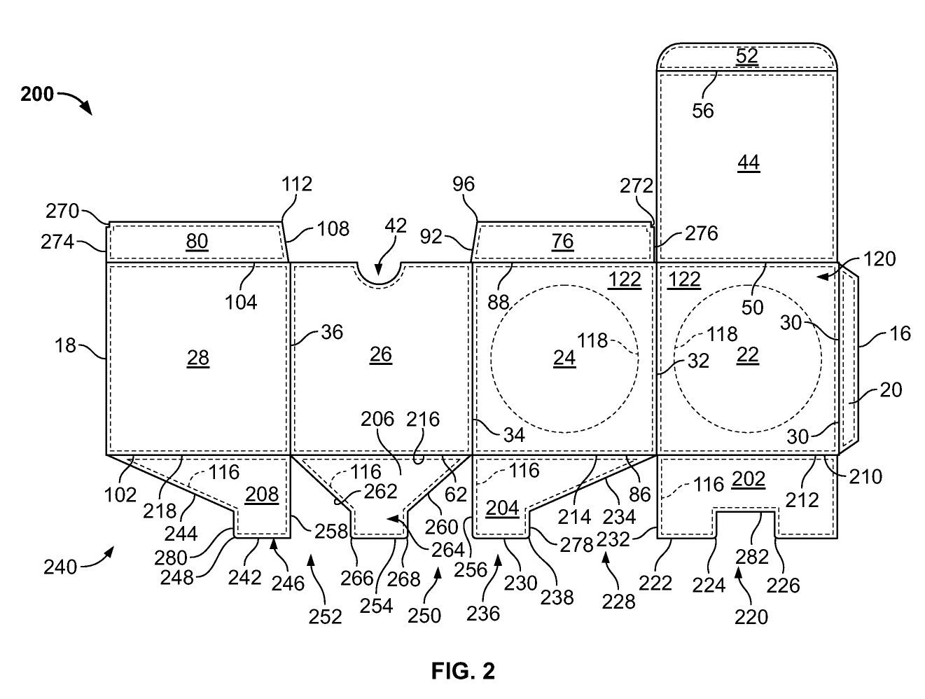

FIG. 2 is a top plan view of an exemplary blank 200 of sheet material for constructing a container, according to an alternative embodiment of the present invention. Blank 200 is essentially similar to blank 10 shown in FIG. 1, and, as such, similar components are labeled with similar references. Blank 200, rather than including bottom panel 46 and bottom side flaps 78 and 82, includes a back bottom panel 202, a first side bottom panel 204, a front bottom panel 206, and a second side bottom panel 208. More specifically, back bottom panel 202 extends from a bottom edge 210 of back panel 22 along a fold line 212, first side bottom panel 204 extends from bottom edge 86 of first side panel 24 along a fold line 214, front bottom panel 206 extends from bottom edge 62 of front panel 26 along a fold line 216, and second side bottom panel 208 extends from bottom edge 102 of second side panel 28 along a fold line 218.

In the exemplary embodiment, back bottom panel 202 is generally rectangularly-shaped and includes a cut-out portion 220, which is generally in the shape of a quadrangle. More specifically, cut-out portion 220 is formed in a front edge 222 of back bottom panel 202. Cut-out portion 220 is approximately centered with respect to panel 202. Furthermore, corners 224 and 226 are formed where cut-out portion 220 and edge 222 intersect. Although corners 224 and 226 are shown as arcuate, corners 224 and/or 226 may be other than arcuate. Alternatively, rather than including cut-out portion 220 as described above, back bottom panel 202 may include any suitable configuration that enables back bottom panel 202 and front bottom panel 206 to interlock, as described in more detail below.

First side bottom panel 204 is generally rectangularly-shaped and includes a trapezoidal cut-out portion 228 in a side edge 230 of panel 204. More specifically, trapezoidal cut-out portion 228 is at least partially defined by a side edge 232 of back bottom panel 202 such that the longer edge of the trapezoid defining cut-out portion 228 is adjacent to back bottom panel 202. Trapezoidal cut-out portion 228 defines an angled edge 234 and a projection 236 of first side bottom panel 204 such that projection 236 is adjacent front bottom panel 206. In another embodiment, corner 238 may be other than arcuate. Also in another embodiment, first side bottom panel 204 includes any suitable configuration that enables first side bottom panel 204 to at least partially form a bottom wall, such as bottom wall 305 (shown in FIG. 3) and/or 405 (shown in FIG. 4), as described in more detail below.

Similarly, second side bottom panel 208 is generally rectangularly-shaped and includes a trapezoidal cut-out portion 240 in a side edge 242 of panel 208. More specifically, trapezoidal cut-out portion 240 is at least partially defined in panel 208 such that the longer edge of the trapezoid defining cut-out portion 240 is substantially aligned with trailing edge 18. Trapezoidal cut-out portion 240 defines an angled edge 244 and a projection 246 of second side bottom panel 208 such that projection 246 is adjacent front bottom panel 206. In the exemplary embodiment, projection 246 is approximately the same size as projection 236. In another embodiment, corner 248 may be other than arcuate. Also in another embodiment, second side bottom panel 208 includes any suitable configuration that enables second side bottom panel 208 to at least partially form a bottom wall, such as bottom wall 305 (shown in FIG. 3) and/or 405 (shown in FIG. 4), as described in more detail below.

In the exemplary embodiment, front bottom panel 206 is generally rectangularly-shaped and includes opposing trapezoidal cut-out portions 250 and 252 in a back edge 254 of panel 206. More specifically, trapezoidal cut-out portion 250 is at least partially defined by a front edge 256 of first side bottom panel 204 such that the longer edge of the trapezoid defining cut-out portion 250 is adjacent to first side bottom panel 204, and trapezoidal cut-out portion 252 is at least partially defined by a front edge 258 of second side bottom panel 208 such that the longer edge of the trapezoid defining cut-out portion 252 is adjacent to second side bottom panel 208. Trapezoidal cut-out portions 250 and 252 each define a respective angled edge 260 and 262. The shorter edges of the trapezoids defining cut-out portions 250 and 252 define a projection 264 such that projection 264 is approximately centered with respect to front bottom panel 206, and such that projection 264 and cut-out portion 220 substantially align when a container is constructed from blank 200. Projection 264 is sized to fit within cut-out portion 220 of back bottom panel 202. Corners 266 and 268 of projection 264 that are adjacent cut-out portions 250 and 252 are arcuate. In an alternative embodiment, corners 266 and/or 268 may be other than arcuate. In another embodiment, front bottom panel 206 includes any suitable configuration that enables front bottom panel to interlock with back bottom panel 202, as described in more detail below.

Each bottom panel 202, 204, 206, and 208 includes decorative film 116. Alternatively, less than all of panels 202, 204, 206, and 208 include film 116. Blank 200 includes notches 270 and 272 defined in first and second top side flaps 76 and 80. In the exemplary embodiment, notches 270 and 272 are each defined in an edge 274 and 276, respectively, that opposes respective angled edges 108 and 92. Further, corners 96 and 112 of blank 200 are other than arcuate.

To construct container 300 (shown in FIG. 3) and/or container 400 (shown in FIG. 4) from blank 200 shown in FIG. 2, flap 20 and panels 22, 24, 26, and 28 are each rotated about respective fold lines 30, 32, 34, and 36 toward interior surface 12 to form a generally right angle with an adjacent panel 22, 24, 26, and/or 28 and/or flap 20. An adhesive, such as, for example, glue and/or tape, is used to adhere exterior surface 14 of closure flap 20 to interior surface of second side panel 28. As such, first side panel 24 defines a first side wall, such as first side wall 301 (shown in FIG. 3) and/or 401 (shown in FIG. 4); back panel 22 defines a back wall, such as back wall 302 (shown in FIG. 3) and/or 402 (shown in FIG. 4); front panel 26 defines a front wall, such as front wall 303 (shown in FIG. 3) and/or 403 (shown in FIG. 4); and second side panel 28 and closure flap 20 define a second side wall, such as, second side wall 304 (shown in FIG. 3) and/or 404 (shown in FIG. 4).

Bottom side panels 204 and 206 are each rotated about respective fold lines 214 and 218 toward interior surface 12 of each respective side panel 24 and 28 to form a generally right angle with each side panel 24 and 28. One projection 236 and/or 246 at least partially overlaps the other projection 236 and/or 246 and a back edge 278 of projection 236 is substantially aligned with a back edge 280 of projection 246 when panels 204 and 208 are rotated as described above. Back bottom panel 202 is rotated about fold line 212 toward interior surface 12 of back panel 22 to form a generally right angle with back panel 22. A front edge 282 of cut-out portion 220 is substantially parallel to, but slightly separated from, back edges 278 and 280 of projections 236 and 246, respectively, such that a gap (not shown) is defined between edge 282 and edges 278 and 280 when panel 202 is rotated as described above. Further, exterior surface 14 of each bottom side panel 204 and 208 is adjacent to interior surface 12 of back bottom panel 202. Front bottom panel 206 is rotated about fold line 216 such that projection 264 substantially aligns with cut-out portion 220. Projection 264 is at least partially received within the gap described above to secure panels 202, 204, 206, and 208 together to form a bottom wall, such as bottom wall 305 (shown in FIG. 3) and/or 405 (shown in FIG. 4).

Top side flaps 76 and 80 are each rotated about respective fold lines 88 and 104 toward interior surface 12 of each respective side panel 24 and 28 to form a generally right angle with each side panel 24 and 28. Top panel 44 is rotated about fold line 50 toward interior surface 12 of back panel 22 to form a generally right angle with back panel 22. An exterior surface 14 of each top side flap 76 and 80 is adjacent to interior surface 12 of top panel 44. Top tuck flap 52 is rotated about fold line 56 such that exterior surface 14 of flap 52 is adjacent to interior surface 12 of front panel 26 to secure top panel 44 in place. As such, top panel 44 and top side flaps 76 and 80 define a top wall, such as top wall 306 (shown in FIG. 3) and/or 406 (shown in FIG. 4). Once container 300 and/or 400 is constructed, container 300 and/or 400 may hold any suitable item or items.

FIG. 3 is a perspective view of an exemplary embodiment of a container 300 constructed from blank 10. Alternatively, container 300 may be constructed from blank 200. Container 300 includes decorative film 116 (described above) to create the appearance of a three-dimensional object 308, such as, for example, a sphere, floating within container 300. More specifically, back wall 302 includes a first holographic region 310 and a second holographic region 312, second side wall 304 includes a first holographic region 314 and a second holographic region 316, and top wall 306 includes a first holographic region 318 and a second holographic region 320. In the exemplary embodiment, first holographic regions 310, 314, and 318 are more reflective than second holographic regions 312, 316, and 320. Lens pattern 122 in each first holographic region 310, 314, and 318 visually creates a portion of three-dimensional object 308, and lens pattern 122 in each second holographic region 312, 316, and 320 visually creates a volume of space 321 between exterior surface 14 of container 300 and object 308. Although only three walls 302, 304, and 306 are shown as including film 116, walls 301, 303, and/or 305 may also include film 116. Moreover, regions 310, 312, 314, 316, 318, and 320 as illustrated and described are exemplary only, and regions 310, 312, 314, 316, 318, and/or 320 may appear to move with respect to container 300 as container 300 is viewed from different angles.

In the exemplary embodiment, pattern 122 is configured such that each first holographic region 310, 314, and/or 318 is adjacent another first holographic region 310, 314, and/or 318. More specifically, first holographic region 310 is adjacent to first holographic region 318 along a top edge 322 and is adjacent to first holographic region 314 along a side edge 324, and first holographic region 314 is adjacent to first holographic region 318 along a top edge 326. The lens pattern 122 is further configured such that each second holographic region 312, 316, and 320 at least partially surrounds a respective first holographic region 310, 314, and 318, and such that each second holographic region 312, 316, and/or 320 is adjacent another second holographic region 312, 316, and/or 320. In other words, the combination of regions 310, 312, 314, 316, 318, and 320 produces a holographic image of a continuous three-dimensional object 308 floating within a continuous volume of space 321, where volume of space 321 surrounds object 308 and appears to be positioned between object 308 and exterior surface 14 of container 300.

FIG. 4 is a perspective view of an alternative exemplary embodiment of a container 400 constructed from blank 10. Alternatively, container 400 may be constructed from blank 200. Container 400 is substantially similar to container 300, as described above, and, as such, similar components are labeled with similar references. More specifically, container 400 is substantially similar to container 300 with the exception that container 400 includes boarder regions 408, 410, and 412 in addition to first holographic regions 310, 314, and 318 and second holographic regions 312, 316, and/or 320, as described above.

In the exemplary embodiment, a first border region 408 is defined along a perimeter of back wall 402 such that region 408 has a substantially uniform thickness T₁, a second border region 410 is defined along a perimeter of second side wall 404 such that region 410 has a substantially uniform thickness T₂, and a third border region 412 is defined along a perimeter of top wall 406 such that region 412 has a substantially uniform thickness T₃. In an alternative embodiment, one or more of thicknesses T₁, T₂, and/or T₃ is other than substantially uniform around each wall perimeter, such that, for example, border regions 408, 410, and/or 412 may undulate, may include peaks and valleys, and/or may include any other design that enables container 400 to function as described herein. In the exemplary embodiment, border regions 408, 410, and 412 combine to visually create a reflective enclosure 414 surrounding space 321 and floating object 308. Border regions 408, 410, and 412 include decorative film 116, where the portion of decorative film 116 in border regions 408, 410, and 412 does not include lens pattern 122 defined therein. In an alternative embodiment, border regions 408, 410, and/or 412 include a lens pattern (not shown) other than lens pattern 122. In another embodiment, one or more border regions 408, 410, and/or 412 may be other than reflective. In the exemplary embodiment, holographic regions 310, 312, 314, 316, 318, and 320 and border regions 408, 410, and 412 combine to create the appearance that object 308 is floating within space 321, where space 321 is defined within enclosure 414 formed by border regions 408, 410, and 412.

The above-described container and methods of constructing the container provide a container that displays a holographic image of a floating three-dimensional object and is easily constructed from a unitary blank of suitable material, such as, a flexible material, a semi-flexible material, and/or a rigid material. Furthermore, the floating object, created from decorative film applied to the container facilitates increasing the marketability of the container and/or the item contained therein.

The exemplary embodiment of the above-described container is a cube-shaped container having solid sides with a specific lens pattern attached to the outside of the cube, wherein the lens pattern is positioned on at least two adjacent walls to combine to visually create a three-dimensional object suspended within the container. In alternative embodiments, the lens pattern is applied to containers having a shape other than a cube, for example, a pyramid, a multi-faceted prism, a geometric solid, a polyhedron, a three-dimensional geometric figure, and/or any other suitable shape that enables creating the effect of a three-dimensional object floating within the container. The lens patterns on each of the walls individually provide a portion of the three-dimensional effect. However, when all of the walls include the lens pattern, the pattern gives the optical illusion of an object, such as a sphere, inside a container. This floating object can be viewed from all angles and from all sides.

Further, the above-described exemplary container is a six-sided container with a film utilizing a holographic lens pattern attached thereto that creates the image of a three-dimensional floating sphere inside the cube. In one embodiment, the holographic lens pattern is positioned on five sides of a cube-shaped container, although the lens pattern may only be placed on at least two adjacent walls of the box. Such placement enables the two panels having the lens pattern to cooperate to visually create a three-dimensional image suspended within the container. Moreover, the container may be made of laminated board or paper applied to a decorative film having a lens pattern therein.

Exemplary embodiments of a container that includes a decorative film displaying a holographic image of a three-dimensional object have been described above in detail. The container is not limited to the specific embodiments described herein, but rather, components of the container and/or steps of the method may be utilized independently and separately from other components and/or steps described herein. Further, the described components and/or method steps can also be defined in, or used in combination with, other apparatus and/or methods, and are not limited to practice with only the apparatus and method as described herein.

While the invention has been described in terms of various specific embodiments, those skilled in the art will recognize that the invention can be practiced with modification within the spirit and scope of the claims.

What is claimed is:

1. A container constructed from a blank of foldable sheet material, said container comprising a decorative film attached to an exterior surface of said container, said container comprising:
a top wall and an opposing bottom wall, a back wall and an opposing front wall, and a pair of opposing side walls, wherein a first one of said walls and an adjacent second one of said walls comprises said decorative film, said decorative film comprising a holographic lens pattern thereon, said holographic lens pattern displaying an image of an object suspended within said container when both of said first and second walls are viewed together.

2. A container in accordance with claim 1 wherein said holographic lens pattern comprises a first holographic region and a second holographic region.

3. A container in accordance with claim 2 wherein a first holographic region on said first wall is adjacent to a first holographic region on said second wall.

4. A container in accordance with claim 2 wherein said first holographic region visually creates said object and said second holographic region visually creates a volume of space.

5. A container in accordance with claim 4 wherein said volume of space appears to extend between said object and said exterior surface of said container such that said object appears to be a three-dimensional object.

6. A container in accordance with claim 2 wherein said first holographic region and said second holographic region appear to move with respect to said walls when said container is viewed from different angles.

7. A container in accordance with claim 2 wherein said second holographic region appears to at least partially surround a corresponding first holographic region.

8. A container in accordance with claim 1 wherein said object is a sphere.

9. A container in accordance with claim 1 wherein each of said walls are substantially square and said walls are substantially equal in size.

10. A container in accordance with claim 1 wherein said holographic lens pattern comprises a metallic layer.

11. A container in accordance with claim 1 wherein at least one of said first wall and said second wall includes a region void of said holographic lens pattern.

12. A container in accordance with claim 11 wherein said region void of said holographic lens pattern extends substantially along a perimeter of at least one of said first wall and said second.

13. A container in accordance with claim 11 wherein said region void of said holographic lens pattern comprises a metallic layer.

14. A method of constructing a container from a blank of foldable sheet material, wherein the container includes a decorative film including a holographic lens pattern, said method comprising:
providing a blank comprising a plurality of panels connected along a plurality of fold lines;
providing the decorative film on a first panel of the plurality of panels and a second panel of the plurality of panels such that the second panel is adjacent to the first panel; and
configuring the holographic lens pattern to visually create an image of a three-dimensional object suspended within the container when the first and second panels are viewed together.

15. A method in accordance with claim 14 wherein configuring the holographic lens pattern further comprises configuring the holographic lens pattern with a first visually created region and a second visually created region.

16. A method in accordance with claim 15 wherein configuring the holographic lens pattern with a first visually created region and a second visually created region further comprises:
configuring the first visually created region to display the three-dimensional object; and
configuring the second visually created region to display a volume of space at least partially surrounding the three-dimensional object.

17. A method in accordance with claim 14 wherein providing the decorative film on a first panel of the plurality of panels and a second panel of the plurality of panels further comprises providing a decorative film comprising a region void of the holographic lens pattern.

18. A method in accordance with claim 14 wherein configuring the holographic lens pattern to visually create an image of a three-dimensional object further comprises configuring the lens pattern to visually create an image of a sphere.

19. A method in accordance with claim 14 wherein providing the decorative film on a first panel of the plurality of panels and a second panel of the plurality of panels further comprises providing a decorative film comprising a metallic layer.

20. A method in accordance with claim 14 wherein providing a blank comprising a plurality of panels connected along a plurality of fold lines further comprises providing a blank comprising a plurality of quadrangular-shaped panels.

21. A container constructed from a blank of foldable sheet material, said container comprising a decorative film attached to an exterior surface of said container, said container comprising:
at least two side walls adjacent to one another, wherein said at least two side walls comprise said decorative film, said decorative film comprising a holographic lens pattern thereon, said holographic lens pattern displaying an image of an object suspended within said container when both of said side walls are viewed together.

22. A container in accordance with claim 21 further comprising a bottom wall adjacent to said at least two side walls, said container forming a pyramid.

23. A container in accordance with claim 21 further comprising:
a bottom wall adjacent to at least one of said at least two side walls, said container forming a polyhedron.

24. A container in accordance with claim 21 further comprising:
a bottom wall adjacent to said at least two side walls; and
a top wall opposing said bottom wall, said container forming a cube.
